(19) United States
(12) Patent Application Publication
(10) Pub. No.: US 2007/0234118 A1
(43) Pub. Date: Oct. 4, 2007

(54) Managing communications paths

(76) Inventors: Steven D. Sardella, Hudson, MA (US); Douglas Sullivan, Hopkinton, MA (US); William Buckley, Brighton, MA (US); Christopher F. Towns, Framingham, MA (US)

Correspondence Address: RICHARD M. SHARKANSKY, PO BOX 557, MASHPEE, MA, 02649, US

(21) Appl. No.: 11/393,230

(22) Filed: Mar. 30, 2006

(51) Int. Cl. G06F 11/00

(52) U.S. Cl. 714/23

(57) ABSTRACT

Communications paths are managed. An error is detected on a first storage processor. It is determined that the error resulted from a peer-to-peer communication from a second storage processor. The error on the first storage processor is handled by taking action short of causing the first storage processor to reset.

### FIELD OF THE INVENTION

The present invention relates generally to the field of storage systems, and particularly to managing communications paths.

### BACKGROUND OF THE INVENTION

The need for high performance, high capacity information technology systems is driven by several factors. In many industries, critical information technology applications require outstanding levels of service. At the same time, the world is experiencing an information explosion as more and more users demand timely access to a huge and steadily growing mass of data including high quality multimedia content. The users also demand that information technology solutions protect data and perform under harsh conditions with minimal data loss.

As is known in the art, large computer systems and data servers sometimes require large capacity data storage systems. One type of data storage system is a magnetic disk storage system. Here a bank of disk drives and the computer systems and data servers are coupled together through an interface. The interface includes storage processors that operate in such a way that they are transparent to the computer. That is, data is stored in, and retrieved from, the bank of disk drives in such a way that the computer system or data server merely thinks it is operating with one memory. One type of data storage system is a RAID data storage system. A RAID data storage system includes two or more disk drives in combination for fault tolerance and performance.

One conventional data storage system includes two storage processors for high availability. Each storage processor includes a respective send port and receive port for each disk drive. Accordingly, if one storage processor fails, the other storage processor has access to each disk drive and can attempt to continue operation.

In the conventional data storage system, each storage processor further includes a parallel bus device. A direct memory access (DMA) engine of each storage processor then engages in DMA-based store and retrieve operations through the parallel bus devices to form a Communication Manager Interface (CMI) path between the storage processors. As a result, each storage processor is capable of mirroring data in the cache of the other storage processor. With data mirrored in the caches, the storage processors are capable of operating in a write-back manner for improved response time (i.e., the storage processors are capable of committing to data storage operations as soon as the data is mirrored in both caches since the data remains available even if one storage processor fails).

An I/O interconnect architecture that is intended to support a wide variety of computing and communications platforms is the Peripheral Component Interconnect (PCI) Express architecture described in the PCI Express Base Specification, Rev. 1.0a, Apr. 15, 2003 (hereinafter, “PCI Express Base Specification” or “PCI Express standard”). The PCI Express architecture describes a fabric topology in which the fabric is composed of point-to-point links that interconnect a set of devices. For example, a single fabric instance (referred to as a “hierarchy”) can include a Root Complex (RC), multiple endpoints (or I/O devices) and a switch. The switch supports communications between the RC and endpoints, as well as peer-to-peer communications between endpoints. The PCI Express architecture is specified in layers, including software layers, a transaction layer, a data link layer and a physical layer. The software layers generate read and write requests that are transported by the transaction layer to the data link layer using a packet-based protocol. The data link layer adds sequence numbers and CRC to the transaction layer packets. The physical layer transports data link packets between the data link layers of two PCI Express agents.

The switch includes a number of ports, with at least one port being connected to the RC and at least one other port being coupled to an endpoint as provided in the PCI Express Base Specification. The RC, switch, and endpoints may be referred to as “PCI Express devices”.

The switch may include ports connected to non-switch ports via corresponding PCI Express links, including a link that connects a switch port to a root complex port. The switch enables communications between the RC and endpoints, as well as peer-to-peer communications between endpoints. A switch port may be connected to another switch as well.

The RC is referred to as an “upstream device”; each endpoint is referred to as a “downstream device”; a root complex's port is referred to as a “downstream port”; a switch port connected to the upstream device is referred to as an “upstream port”; switch ports connected to downstream devices are referred to as “downstream ports”; and endpoint ports connected to the downstream ports of the switch are referred to as “upstream ports”.

Typically, the switch has a controller subsystem which is a virtual port for the system. The controller subsystem has the intelligence for the switch and typically contains a microcontroller. The controller subsystem is in communication with the switch's other ports to set the configuration for the ports on power up of the system, to check the status of each of the ports, to process transactions which terminate within the switch itself, and to generate transactions which originated from the switch itself. For example, the switch might receive a packet requesting that a register in one of the ports be read. The microcontroller subsystem would read that register via an internal control bus and then generate a return packet that is transmitted. If the data in the register indicated that an error had occurred, the return packet could be an error packet which would be sent via the upstream port to notify the root complex that the error has occurred.

As noted above, in PCI Express, information is transferred between devices using packets. In order to meet various transactions such as a memory write request, a memory read request, an I/O write request and an I/O read request, not only packets including a header and variable-length data, but also packets including only a header and not data are used in the PCI Express. For example, a memory read request packet that makes a memory read request and an I/O read request packet that makes an I/O read request each include only a header.

Credit-based flow control is used in PCI Express. In this flow control, a receiving device previously notifies a transmitting device of a credit indicative of the size of an effective receiving buffer in the receiving device as flow control information. The transmitting device can transmit information for the size specified by the credit. In PCI Express, for example, a timer can be used as a method for transmitting credits regularly from the receiving device to the transmitting device.

At least some of the end points may share an address domain, such as a memory address domain or an I/O address domain. The term “address domain” means the total range of addressable locations. If the shared address domain is a memory address domain, then data units are transmitted via memory mapped I/O to a destination address into the shared memory address domain. There may be more than two address domains, and more than one address domain may be shared. The address domains are contiguous ranges. Each address domains is defined by a master end point. Address portions associated with the individual end points may be non-contiguous and the term “portions” is meant to refer to contiguous and non-contiguous spaces. The master end point for a given address domain allocates address portions to the other end points which share that address domain. The end points communicate their address space needs to a master device, and the master device allocates address space accordingly.

Data units may be written into or communicated into an address portion. In a switch conforming to the PCI Express standard, it is expected that the address portions in a 32-bit shared memory address domain or shared I/O address domain will be at least as large as the largest expected transaction. A non-shared address domain is considered isolated from the shared address domain. Other non-shared address domains could be included, and they would also be considered isolated from the shared address domain, and from each other. By “isolated” it is meant that the address domains are separated such that interaction does not directly take place between them, and therefore uniquely addressable addresses are provided.

Data units may be directed to one or more of the end points by addressing. That is, a destination address is associated with and may be included in the data units. The destination address determines which end point should receive a given data unit. Thus, data units addressed to the individual portion for a given end point should be received only by that end point. Depending on the embodiment, the destination address may be the same as the base address or may be within the address portion.

The end points may be associated with respective ports. Through this association, a given end point may send data units to and receive data units from its associated port. This association may be on a one-to-one basis. Because of these relationships, the ports also have associations with the address portions of the end points. Thus, the ports may be said to have address portions within the address domains.

Ports within a shared addressed domain are considered “transparent”, and those not within a shared address domain are considered “non-transparent”. Data units from one transparent port to another may be transferred directly. However, data units between a transparent port and a non-transparent port require address translation to accommodate the differences in their respective address domains. Transparent ports are logical interfaces within a single addressing domain. Non-transparent ports allow interaction between completely separate addressing domains, but addresses from one domain must be converted from one domain to the other.

The status of a port—transparent or non-transparent—may be fixed or configurable. Logic may allow designation on a port-by-port of transparency or non-transparency, including the address domain for a given port. The switch may be responsive to requests or instructions from devices to indicate such things as which address domain the devices will be in, and the address portion associated with a given device.

Domain maps for each address domain may be communicated to the switch. There may be provided a master end point, such as a processor, which is responsible for allocating address portions within its address domain. End points may communicate their address space needs to a master device, and the master device may allocate address space accordingly. The master device may query end points for their address space needs. These allocations, and other allocations and designations, define the address map which the master end point communicates to the switch. The switch may receive a single communication of an address map from a master end point. The switch may receive partial or revised address maps from time to time.

If a destination address is associated with a non-transparent port, the switch translates the address. Many different schemes of memory and I/O address translation for mapping from one address domain into another may be used. These schemes include direct memory translation both with and without offsets, and indirect memory translation through lookup registers or tables. Other schemes may be used, such as mailbox and doorbell registers that allow for messages to be passed and interrupts generated across the non-transparent port, from one domain to the other.

In effect, non-transparent ports allow data transfers from one address domain to another. A device connected to a non-transparent port of the switch is isolated from the address domain of the other ports on the switch. Two or more processors with their own address maps could all communicate with each other through this type of PCI Express switch.

PCI Express communications rely on a process of error detection and handling. Under current PCI Express standards, PCI parity bit errors that occur during read or write transactions are passed to PCI Express using an error-poisoned (EP) bit in the PCI Express packet header. This EP bit indicates that data in the packet is invalid, but does not distinguish the specific location of the error within the data payload. Thus, setting the EP bit during a PCI Express read or write transaction invalidates the entire data payload. Even if there is only a single parity error, in one doubleword (DW) out of a large PCI data payload, the EP bit invalidates the entire transaction. (Since a packet protection technology known as End-to-end Cyclic Redundancy Check (ECRC) is not currently standard on all PCI Express devices, it has limited usefulness, at best, for a practical, robust solution.)

Such transactions are often used in a modern computer architecture that may be viewed as having three distinct subsystems which when combined, form what most think of when they hear the term computer. These subsystems are: 1) a processing complex; 2) an interface between the processing complex and I/O controllers or devices; and 3) the I/O (i.e., input/output) controllers or devices themselves. A processing complex may be as simple as a single microprocessor, such as a standard personal computer microprocessor, coupled to memory. Or, it might be as complex as two or more processors which share memory.

A blade server is essentially a processing complex, an interface, and I/O together on a relatively small printed circuit board that has a backplane connector. The blade is made to be inserted with other blades into a chassis that has a form factor similar to a rack server today. Many blades can be located in the same rack space previously required by just one or two rack servers. Blade servers typically provide all of the features of a pedestal or rack server, including a processing complex, an interface to I/O, and I/O. Further, the blade servers typically integrate all necessary I/O because they do not have an external bus which would allow them to add other I/O on to them. So, each blade typically includes such I/O as Ethernet (10/100, and/or 1 gig), and data storage control (SCSI, Fiber Channel, etc.).

The interface between the processing complex and I/O is commonly known as the Northbridge or memory control hub (MCH) chipset. On the “north” side of the chipset (i.e., between the processing complex and the chipset) is a bus referred to as the HOST bus. The HOST bus is usually a proprietary bus designed to interface to memory, to one or more microprocessors within the processing complex, and to the chipset. On the “south” side of the chipset are a number of buses which connect the chipset to I/O devices. Examples of such buses include: ISA, EISA, PCI, PCI-X, and PCI Express.

### SUMMARY OF THE INVENTION

Communications paths are managed. An error is detected on a first storage processor. It is determined that the error resulted from a peer-to-peer communication from a second storage processor. The error on the first storage processor is handled by taking action short of causing the first storage processor to reset.

One or more embodiments of the invention may provide one or more of the following advantages.

A robust error handling system can be provided for a PCI Express based peer to peer path between storage processors in a data storage system. The peer to peer path can rely on push techniques without excessive risk of duplicating fatal errors. Existing error handling can be leveraged to facilitate error analysis and component service.

Other advantages and features will become apparent from the following description, including the drawings, and from the claims.

### BRIEF DESCRIPTION OF THE DRAWINGS

FIG. 1 is an isometric view of a storage system in which the invention may be implemented.

FIG. 2 is a schematic representation of a first configuration of the system of FIG. 1 showing blades, two expansion slots, and two I/O modules installed in the expansion slots.

FIG. 3 is a schematic representation of a second configuration of the system of FIG. 1 showing the blades, two expansion slots, and one shared cache memory card installed in both the expansion slots.

FIG. 4 is a schematic representation of a system that may be used with the system of FIG. 1.

FIG. 5A-5C are sample illustrations of data for use in the system of FIG. 4.

FIG. 6 is a flow diagram of a procedure for use in the system of FIG. 4.

### DETAILED DESCRIPTION

In a multi-bladed architecture, in which two or more blades are connected via PCI-Express, and in which one blade can DMA into another blade's memory, errors created on one blade can propagate to the other. Depending on specific implementations and error types as described below, these could happen silently, or there could be a race condition between when the errors are detected, and when the erroneous data is used. In addition to errors that occur on the PCI-Express bus itself, components along the entire path between the two blades' memory systems could fail internally. Described below are robust methodologies and practices, for detecting these non-standard forms of corruption, correctly determining the domain of their origin or destination, and reducing or eliminating the possibility that more than one blade can be affected. This relies on a coordination of multiple levels of error handling software and component software drivers.

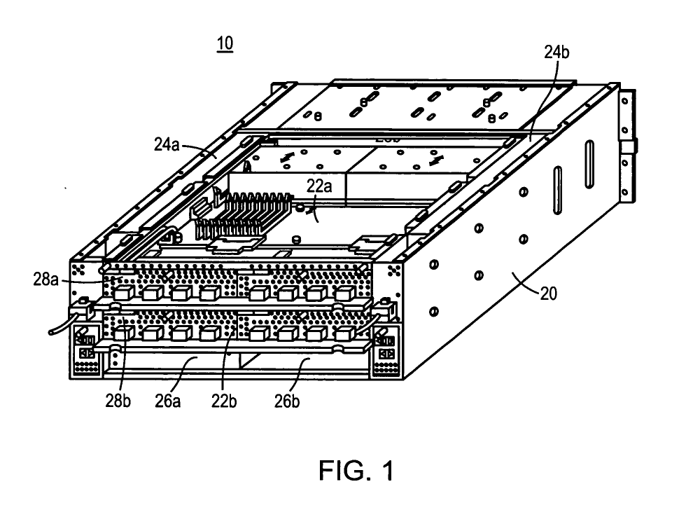

Referring to FIG. 1, there is shown a portion of a storage system 10 that is one of many types of systems in which the principles of the invention may be employed. The storage system 10 shown may operate stand-alone or may populate a rack including other similar systems. The storage system 10 may be one of several types of storage systems. For example, if the storage system 10 is part of a storage area network (SAN), it is coupled to disk drives via a storage channel connection such as Fibre Channel. If the storage system 10 is, rather, a network attached storage system (NAS), it is configured to serve file I/O over a network connection such as an Ethernet.

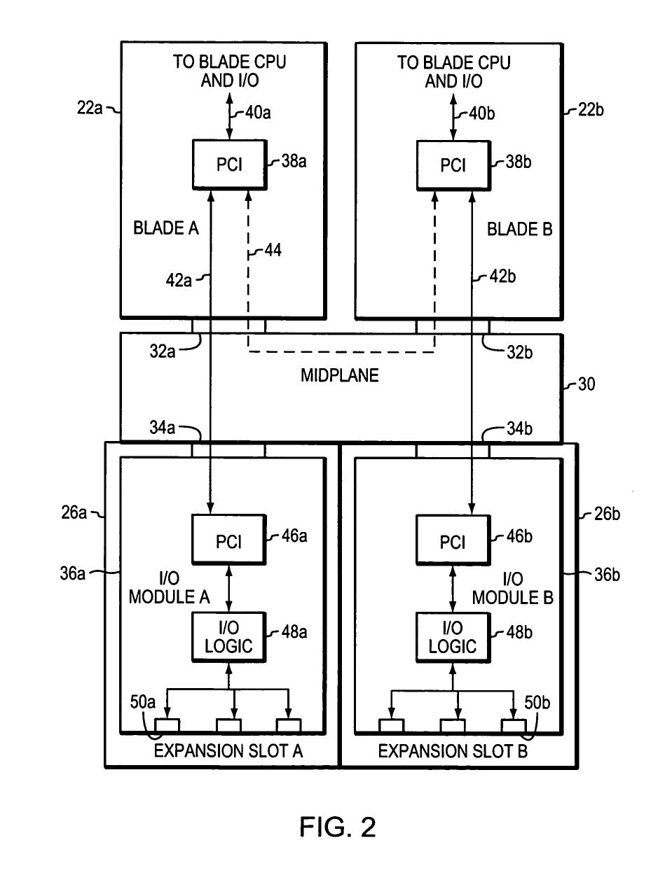

The storage system 10 includes within a chassis 20 a pair of blades 22a and 22b, dual power supplies 24a,b and dual expansion slots 26a,b. The blades 22a and 22b are positioned in slots 28a and 28b respectively. The blades 22a,b include CPUs, memory, controllers, I/O interfaces and other circuitry specific to the type of system implemented. The blades 22a and 22b are preferably redundant to provide fault tolerance and high availability. The dual expansion slots 26a,b are also shown positioned side by side and below the blades 22a and 22b respectively. The blades 22a,b and expansion slots 26a,b are coupled via a midplane 30 (FIG. 2). In accordance with the principles of the invention, the expansion slots 26a,b can be used in several ways depending on system requirements.

In FIG. 2, the interconnection between modules in the expansion slots 26a,b and the blades 22a,b is shown schematically in accordance with a first configuration. Each blade 22a,b is coupled to the midplane 30 via connectors 32a,b. The expansion slots 26a,b are also shown coupled to the midplane 30 via connectors 34a,b. The blades 22a,b can thus communicate with modules installed in the expansion slots 26a,b across the midplane 30. In this configuration, two I/O modules 36a and 36b are shown installed within the expansion slots 26a and 26b respectively and thus communicate with the blades 22a,b separately via the midplane 30.

In accordance with a preferred embodiment, the blades 22a,b and I/O modules 36a,b communicate via PCI Express buses. Each blade 22a,b includes a PCI Express switch 38a,b that drives a PCI Express bus 40a,b to and from blade CPU and I/O resources. The switches 38a,b split each PCI Express bus 40a,b into two PCI Express buses. One PCI Express bus 42a,b is coupled to the corresponding expansion slot 26a,b. The other PCI Express bus 44 is coupled to the other blade and is not used in this configuration—thus it is shown dotted. The I/O modules 36a,b are PCI Express cards, including PCI Express controllers 46a,b coupled to the respective bus 42a,b. Each I/O module 36a,b includes I/O logic 48a,b coupled to the PCI Express controller 46a,b for interfacing between the PCI Express bus 42a,b and various interfaces 50a,b such as one or more Fibre Channel ports, one or more Ethernet ports, etc. depending on design requirements. Furthermore, by employing a standard bus interface such as PCI Express, off-the-shelf PCI Express cards may be employed as needed to provide I/O functionality with fast time to market.

The configuration of FIG. 2 is particularly useful where the storage system 10 is used as a NAS. The NAS is I/O intensive; thus, the I/O cards provide the blades 22a,b with extra I/O capacity, for example in the form of gigabit Ethernet ports.

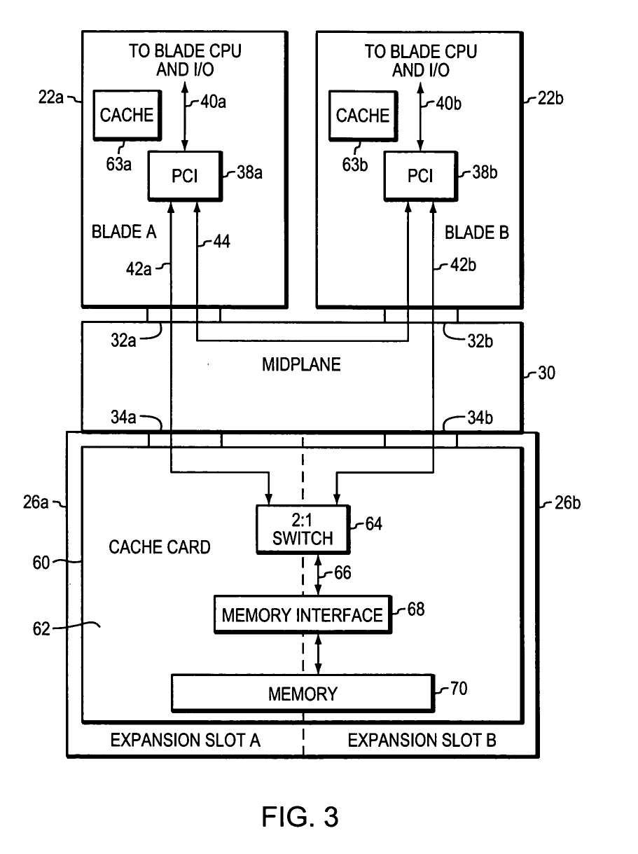

Referring to FIG. 3, there is shown an alternate arrangement for use of the expansion slots 26a,b. In this arrangement, a single shared resource 60 is inserted in both the expansion slots 26a,b and is shared by the blades 22a,b (hereinafter, storage processors or SPs 22a,b). The shared resource 60 may be for example a cache card 62. The cache card 62 is particularly useful for purposes of high availability in a SAN arrangement. In a SAN arrangement using redundant SPs 22a,b as shown, each SP includes cache memory 63a,b for caching writes to the disks. During normal operation, each SP's cache is mirrored in the other. The SPs 22a,b mirror the data between the caches 63a,b by transferring it over the PCI Express bus 44, which provides a Communication Manager Interface (CMI) path between the SPs. If one of the SPs, for example SP 22a, fails, the mirrored cache 63a becomes unavailable to the other SP 22b. In this case, the surviving SP 22b can access the cache card 62 via the PCI Express bus 42b for caching writes, at least until the failed SP 22a recovers or is replaced.

As seen in FIG. 3, the cache card 62 includes a two-to-one PCI Express switch 64 coupled to the PCI Express buses 42a,b. The switch 64 gates either of the two buses to a single PCI Express bus 66 coupled to a memory interface 68. The memory interface 68 is coupled to the cache memory 70. Either SP 22a or 22b can thus communicate with the cache memory 70.

Referring to both FIGS. 2 and 3, it is noted that the PCI Express bus 44 is not used in the NAS arrangement but is used in the SAN arrangement. Were the PCI Express switches 38a,b not provided, the PCI Express bus 40a,b would be coupled directly to the PCI Express bus 44 for SAN functionality and thus would not be usable in the NAS arrangement. Through addition of the switches 38a,b, the PCI Express bus 42a,b is useful in the NAS arrangement when the PCI Express bus 44 is not in use, and is useful in the SAN arrangement during an SP failure. Note that the PCI Express bus 44 and the PCI Express buses 42a,b are not used at the same time, so full bus bandwidth is always maintained.

In at least one embodiment, system 10 includes features described in the following co-pending U.S. patent applications which are assigned to the same assignee as the present application, and which are incorporated in their entirety herein by reference: Ser. No. 10/881,562, docket no. EMC-04-063, filed Jun. 30, 2004 entitled “Method for Caching Data”; Ser. No. 10/881,558, docket no. EMC-04-117, filed Jun. 30, 2004 entitled “System for Caching Data”; Ser. No. 11/017,308, docket no. EMC-04-265, filed Dec. 20, 2004 entitled “Multi-Function Expansion Slots for a Storage System”.

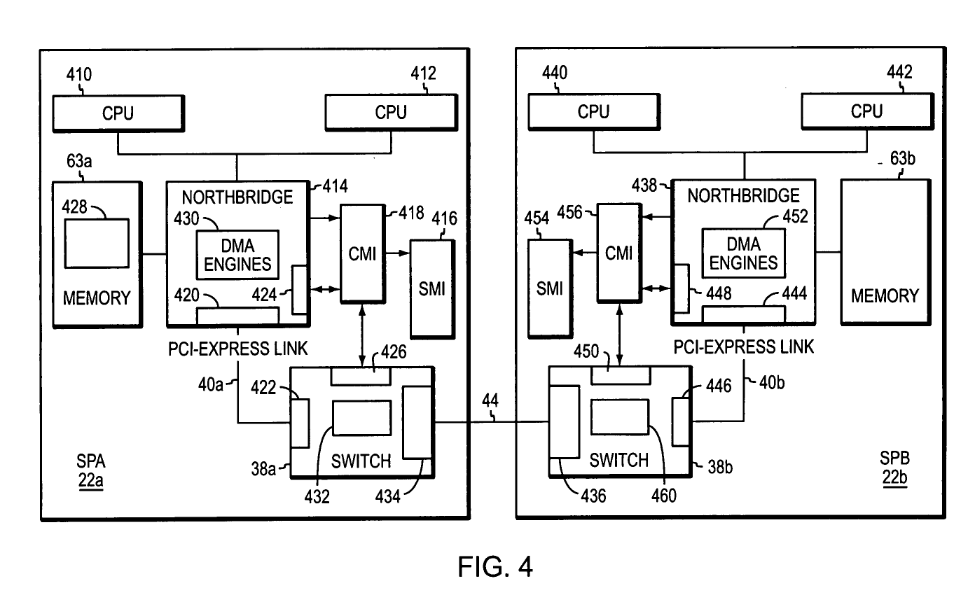

FIG. 4 illustrates details of SPs 22a,b (SPA, SPB, respectively) in connection with interaction for CMI purposes. SPA has Northbridge 414 providing access to memory 63a by CPUs 410, 412 and switch 38a. Bus 40a connects Northbridge port 420 with switch upstream port 422 to provide a PCI Express link between Northbridge 414 and switch 38a. Northbridge 414 and switch 38a also have respective register sets 424, 426 that are used as described below. Memory 63a has buffer 428 that is served by DMA engines 430 of Northbridge 414. Switch 38a has RAM queues 432 in which data is temporarily held while in transit through switch 38a.

System Management Interrupt (SMI) handler 416 and CMI PCI Express driver 418 are software or firmware that interact with each other and other SPA functionality to handle error indications as described below. (In other embodiments, at least some of the actions described herein as being executed by SMI handler 416 could be performed by any firmware or software error handler, e.g., a machine check exception handler, that extracts information from the various components' error registers, logs information, and potentially initiates a reset.)

Bus 44 connects link port 434 of SPA switch 38a and link port 436 of SPB switch 38b to provide the CMI path (peer to peer path) in the form of a PCI Express link between switches 38a,b.

SPB has Northbridge 438 providing access to memory 63b by CPUs 440, 442 and switch 38b. Bus 40b connects Northbridge port 444 with switch upstream port 446 to provide a PCI Express link between Northbridge 438 and switch 38b. Northbridge 438 and switch 38b also have respective register sets 448, 450 that are used as described below. Memory 63b is served by DMA engines 452 of Northbridge 438. Switch 38b has RAM queues 460 in which data is temporarily held while in transit through switch 38b. SPB SMI handler 454 and CMI PCI Express driver 456 are software or firmware that interact with each other and other SPB functionality to handle error indications.

Handlers 416, 454 and drivers 418, 456 help manage the use of PCI Express for the CMI path, since PCI Express alone does not provide suitable functionality. For example, if one of the SPs develops a problem and acts in a way that that is detected by or on the other SP, it is useful to try to avoid unnecessarily concluding that both SPs have the problem, especially if that would mean that both SPs need to be reset or shut down, which would halt the system. Generally, it is useful to determine where the problem started and where the fault lies, so that suitable action is taken to help prevent such a mistaken result.

In particular, with the CMI path relying on PCI Express, data shared between the SPs is “pushed”, i.e., one SP effectively writes the data to the other SP's memory. Each SP's Northbridge DMA engines can perform writes to the other's SP memory but cannot perform reads from the other SP's memory.

In such a write-only system, if the data is contaminated in some way as it is being written to the other SP, the SP with the problem may create a problem for other SP, e.g., may send something to the other SP that is corrupted in some way, and the other SP may be the first to detect the problem. In such cases, each SP needs to respond correctly as described below.

FIG. 4 illustrates that the two Northbridges 414, 438 are connected by two switches 38a,b. A first PCI Express domain (SPA domain) is formed between Northbridge 414 and switch 38a, and a second domain (SPB domain) is formed between Northbridge 438 and switch 38b. A third domain (inter-SP domain) is formed between switches 38a,b. In at least one implementation, error messages cannot traverse domains, in which case error messages pertaining to the inter-SP domain cannot reach either Northbridge 414, 438, so that the underlying error conditions must be detected in another way as described below.

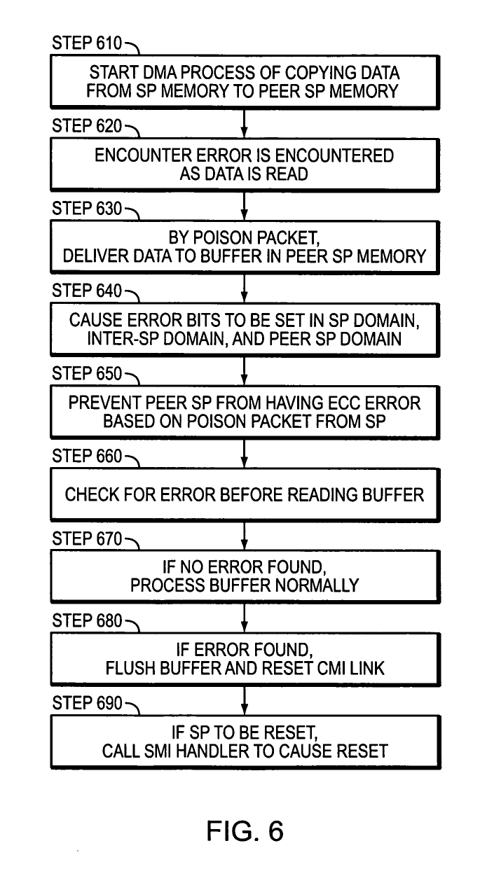

A particular example, now described with reference to FIG. 6, takes into account packets with the EP bit set in the PCI Express packet header (“poison packets”). SPB DMA engines 452 execute to help start the process of copying data from SPB memory 63b to SPA memory 63a (step 610). A double bit ECC (error checking and correction) error is encountered as the data is read from memory 63b (step 620). A poison packet that includes the data travels from Northbridge 438 to switch 38b to switch 38a to Northbridge 414, and the data is put in buffer 428 of memory 63a (step 630). This process causes error bits to be set in the SPB domain, the inter-SP domain, and the SPA domain (step 640). Software or firmware need to detect that these error bits have been set in each of the three domains and take action in a way that does not cause both SPs to be reset. This is necessary because there is only one fault on one piece of hardware, namely SPB, even though error bits seem to indicate faults on both sides of both switches 38a,b, and in both memories 63a,b. This is because the poison packet delivers data but indicates that there is an error associated with the data delivered.

As described above, the error or “poisoning” may originate as an ECC error upon reading the data from memory 63a or 63b, but the poisoning is forwarded by the Northbridges and switches, and is converted to a poison packet in PCI Express.

In the case of an endpoint, such as a PCI Express to Fibre Channel interface controller driven by bus 42a or 42b such that PCI Express does not extend beyond it, poison packets are not forwarded, e.g., are not converted to Fibre Channel packets. However, a switch or a bridge passes poison packets on through and does not take action, and in fact does not poison a packet even if after determining an error internally. But a switch does use other mechanisms to indicate an error, as described below.

Conventionally, when the Northbridge receives a poison packet headed for memory, the packet's data is put into destination memory with the ECC error. In such a case, poisoning is simply continued and if the destination memory location is read, an ECC error is produced that is associated with the destination memory location. A problem in such a case is that conventionally the SP is configured to be reset if an uncorrectable ECC is error is produced when memory is read. This action is taken in the conventional case because, depending on the device involved in the reading of the destination memory location, the data read may be headed toward a Fibre Channel path or another area, and without due attention to an uncorrectable ECC error, corrupted data could spread. In addition, the SP has scrubbing programs running in the background that read every memory location on a repeated basis as a check, and conventionally a resulting correctable ECC error is corrected and a resulting uncorrectable ECC error leads to a reset of the SP.

Thus, allowing for poison forwarding on the link into Northbridge port 420 would be problematic. In particular, as noted above, it could result in resetting both SPs, depending on whether the SP that sent the poison packet also detected it, in which case that SP may determine it needs to be reset.

Thus, with reference again to FIG. 6, in accordance with the invention, the SP is configured to prevent an ECC error from resulting from an inbound poison packet from the CMI link (step 650). This is not the case with ECC errors resulting from poison packets on other PCI Express paths coming into the Northbridge, e.g., from I/O devices such as Ethernet chips and Fibre Channel chips, because such poison packets are the result of a problem on the same SP, so resetting the SP is not an inappropriate reaction.

Such a reset is not executed immediately; when SMI handler 416 or 454 is invoked, it determines why and logs the results in persistent memory, and then if necessary causes a reset of the SP. If the SMI handler is invoked for something that is considered a soft (correctable) error, it logs the error for subsequent analysis and then simply returns. (PCI Express Advanced Error Reporting supports logging of packet headers associated with certain errors. As described herein, this information is logged for debug at a later time. In other implementations, the real-time gathering and analysis of these logs could provide even greater granularity as to the source and path of errors, at least in some cases.)

The SMI runs at the highest level of all interrupts, such that as soon as a triggering event occurs, e.g., as soon as an appropriate poison packet is encountered, a message is sent that generates an SMI. At that point, any other code that is running stops until the SMI handler returns control, if the SMI handler does not cause the SP to be reset.

Since, in accordance with the invention, the SP is configured to prevent an ECC error on an inbound poison packet from the CMI link, bad data that cannot be trusted is being inserted into memory and needs to be dealt with in a way other than the ECC error.

Poisoning can happen on any step of the DMA process, since the process also relies on, for example, RAM queues 432, 460 of switches 38a,b. Absent a defective or noncompliant component, a poison packet should not occur under normal circumstances because it should be caught along the way. For example, when DMA engines 452 read from memory 63b in order to cause a write to memory 63a, if engines 452 receives an uncorrectable ECC error on that read, they should not forward the error by creating a poison packet—they can take action and avoid shipping out the associated data. However, it is suitable to have a robust solution that accounts for a defective or noncompliant component.

In further detail, a DMA process may be executed as follows. DMA engines 452 retrieve data from memory 63b and send a packet including the data to switch 38b, which receives the packet at its port 446 and uses its RAM queues 460 to store the data. At this point switch 38b is to send the data out its port 436 and starts reading data out from queues 460, but gets an uncorrectable error (e.g., a double bit ECC error). Switch 38b continues to push the packet onwards but sets the packet's EP bit thus causing the packet to be a poison packet. One or more error bits are also set in the switch's register set 450. Switch 38a receives the poison packet, sets error bits in register set 426 reporting an error on port 434, puts the data into its RAM queues 432, passes the data on through its port 422, and sets appropriate error bits in set 426. The packet then arrives at Northbridge 414 where the data is put into buffer 428 but, in accordance with the invention, is not marked with an ECC error. (The Northbridge could either mark the buffer's memory region as corrupt or enter the data normally so that when the region is read, its ECC returns no parity error.) At this point bad data is in buffer 428 but no additional error should result from the DMA transaction.

As soon as a poison packet encounters a PCI Express port, error bits are set as noted above to indicate that something is wrong, and to give an opportunity to invoke or not invoke the SMI handler depending on which software entity should handle the situation. For some situations, it is desirable to use the SMI handler for the problem. In particular, for any problem that can be completely bounded within the SP, i.e., that started and was detected within the SP, the SMI handler is appropriate because it can log the error, report an issue with a field replaceable unit (FRU) (“indict a FRU”), and either return control or reset the SP depending on the severity of the error. A version of the SMI handler and its actions are described in co-pending U.S. patent application Ser. No. 10/954,403, docket no. EMC-04-198, filed Sep. 30, 2004 entitled “Method and System for Detecting Hardware Faults in a Computer System” (hereinafter “fault detection patent application”), which is assigned to the same assignee as the present application, and which is incorporated in its entirety herein by reference.

However, if a problem is detected may not have started on the instant SP, i.e., may have started on the peer SP, a more robust layer of software, namely CMI driver 418 or 454, is used that interprets status information beyond the instant SP. For example, if an error occurs in connection with port 420 that indicates that a poison packet passed by (already on its way to memory 63a), driver 418 is invoked at least initially instead SMI handler 416, to help make sure that the error does not spread.

In accordance with the invention, as a result of the DMA process, three components 38b, 38a, 414 produced errors and set corresponding error bits as the data passed by, and the error bits do not cause the SMI handler to be invoked—normal code is allowed to continue to execute. In buffer 428 handled by driver 418, one entry results from the poison packet and holds the data sent from the peer SP in the poison packet. Absent the error, driver 418 would eventually process this entry.

In connection with the DMA process, SPB uses PCI Express to send an interrupt message to trigger a hardware interrupt on SPA, which invokes driver 418. Thus driver 418 gets notification of new data to be read that arrived in the DMA process. However, with reference again to FIG. 6, since as described above it is possible for bad data to enter buffer 428, driver 418 checks bits before reading buffer 428 (step 660). In particular, driver 418 first checks bits to determine whether the new data can be trusted. In a specific implementation, driver 418 checks a bit in Northbridge set 424 because it is the fastest to access and is the closest to CPUs 410, 412. If the bit is not set, the port has not encountered any poisoned data passing by, and therefore it is safe to process buffer 428 normally (step 670). If the bit is set, which means buffer 428 has some bad data (the bit does not indicate how much or where the bad data is), driver 418 completely flushes buffer 428, resets any associated errors, resets the CMI link, and continues on, thus helping to avoid accepting corrupted data (step 680). This is performed for every interrupt message received, so that even if multiple interrupt messages are received, race conditions are avoided. In short, the bit in set 424 is checked before reading every piece of data.

Flushing buffer 428 does not cause any permanent problems because at a higher level in the CMI protocol, if SPB does not receive a proper or timely acknowledgement, it resets the link in any case, which always clear such buffers.

As described in more detail below, in a more general case, tables are used to implement policy on reactions to error indications, e.g., on whether to recover, reset the link, or, in the extreme case, reset or halt use of the SP.

For example, if the error is a soft (correctable) error, such as a one bit ECC error, the error can be logged and processing can continue normally. However, if the error is one indicating a component cannot be trusted, e.g., a double bit ECC error, use of the SP may halted after reset, and/or the CMI link may be treated as untrustworthy. For example, the CMI link may be treated as “degraded” such that it continue to be used for inter-SP communications (e.g., SP status or setup information) but no substantive data (e.g., data storage host data) is sent over it.

In at least some cases, CMI driver 418 or 456 may be invoked by software. In particular, some errors internal to switch 38a or 38b do not cause an error message to be sent out of the inter-SP domain. Thus, such errors need to be detected by interrupt or through polling.

If an error is detected that should lead to resetting the SP, it is still useful to process fault status information as described in above-referenced fault detection patent application. In such a case, with reference to FIG. 6 again, software detects the error, leaves it set, and calls SMI handler 416 (step 690), which will also detect the error and reset the SP with fault status noted.

As described in a general case in the above-referenced fault detection patent application, the SMI handler saves its results in a persistent log, e.g., in nonvolatile memory. By contrast, in at least one implementation the CMI driver saves its results to a log on disk. It can be useful to store error information onboard for repair or failure analysis, even if such information pertains to more than one component.

Also, in at least one implementation, the SMI handler is the only firmware or software that is capable of indicating fault information using a fault status register that the peer SP is polling. As described in above-referenced fault detection patent application, FRU strategy for diagnosis relies on the fault status register that can be read from the peer SP, e.g., over an industry standard I2C interface, and the SMI handler writes to that register to identify components deemed to be insufficiently operative.

As noted above, errors can be detected in all three domains (SPA, SPB, and inter-SP). With respect to SPA and buffer 428, driver 418 acts as described above to detect the problem and clear the buffer if necessary. SPB also has errors as noted above. SPB driver 456 receives notification of a memory error under PCI Express and may invoke handler 454. In particular, SPB detects a double bit ECC error, which is usually fatal, and can conclude that (1) it happened on SPB, and (2) it is of a sufficiently risky nature that it could happen again, and therefore SPB should be reset. Driver 456 invokes handler 454 which preempts all other program execution as described above, finds the error, and executes a process of halting use of SPB, including by persistently storing fault status information in the fault status register identifying faulty hardware, and indicating replacement and/or a reset, while SPA is polling the fault status register. As a result, although the error transpires on both SPs after originating on SPB, the system correctly clears SPA buffer 428 but does not reset SPA, and correctly faults SPB and resets SPB, so that processing continues up through replacement of SPB if necessary as properly indicated by handler 454 after being invoked by driver 456.

In at least some cases, soft errors on the SPs are logged by polling by drivers 418, 456 poll instead of being handled by handlers 416, 454 each of which preempts all of its respective SP's processes including respective driver 418 or 456, which could adversely affect performance. Thus, unlike fatal or non-fatal classes of errors, soft errors generally are masked from SMI and are handled by the CMI drivers. Soft errors may be logged so that a component can be deemed at risk for more significant failure and can be proactively replaced before it fails in a way that causes uncorrectable errors.

The CMI drivers are also responsible for detecting errors that happen in the inter-SP domain between ports 434 and 436. Since error messages cannot traverse domains, an error that happens in the inter-SP domain does not generate an error message to either Northbridge. Thus, for errors occurring in the link over bus 44, the SPs are not automatically notified, and need to be actively looking for them. When an inter-SP error occurs, the SPs need to determine whether one SP can be identified as the source of the error. As noted above in the DMA example, it is preferable to avoid having to reset both SPs when only one originated the fault. Thus, as noted above, the action taken depends on the type of error: for example, if benign, it is merely logged; if it indicates faulty hardware, the CMI link may be degraded.

The driver has two main ways to detect errors: software interrupts, and by polling register sets. Here, when polling for soft errors, inter-SP errors are included as well.

In general with respect to register sets 424, 426, 450, 448, PCI Express defines different types of error reporting for devices that support advanced error reporting: registers known as correctable and uncorrectable status registers are provided. Each switch can report “don't cares” (which are merely logged), and other errors for which use of an SP needs to be halted or use of a connection such as the CMI link needs to be halted or changed out of loss of trust. Errors are varied: some are point-to-point errors that indicate that a connection (a PCI Express link) has an issue, but do not reveal anything about the rest of the system, others (e.g., poison packets) are forwarded so that the origin is unclear but they are caught going by, and still others are errors that are introduced in communications heading to a peer SP or coming in from a peer SP and need to be kept from spreading.

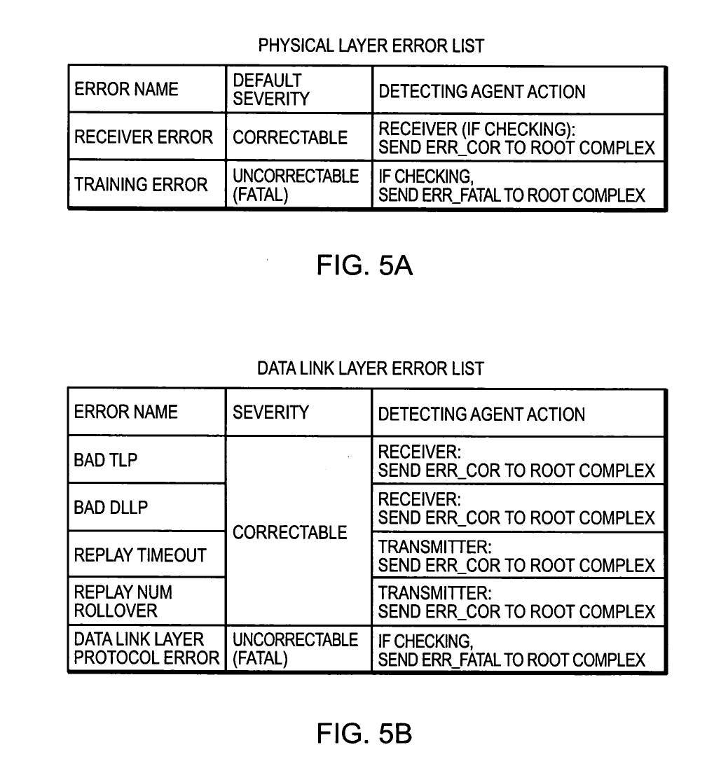

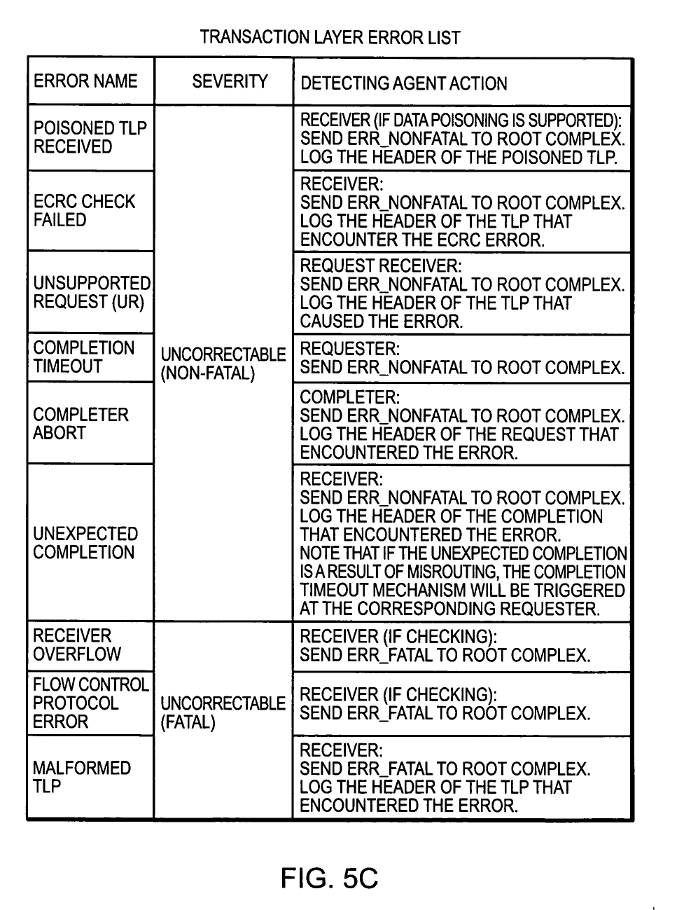

FIGS. 5A-5C illustrate a sample set of tables describing a policy for a sample set of errors described in the PCI Express Base Specification. Depending on whether an error is bounded within an SP or might be the result of a fault on another SP, different action may be taken.

Each Northbridge has correctable and uncorrectable status registers among sets 424 or 448 for each PCI Express port, including port 420 or 444 for the CMI link. Switch register sets 426, 450 include separate sets of registers on the upstream side (ports 422, 446) and downstream side (ports 434, 436). Each driver 418 or 456 checks its respective Northbridge set 424 or 448 for errors to report, and switch set 426 or 450 for errors to report, and depending on what the error is, may respond differently.

In another example, a significant error is receiver overflow, which leads to degrading the CMI link as quickly as possible. In PCI Express, when a receiver overflow error is received, it means a credit mismatch exists. The system of credits is used for flow control handshaking in which one side can call for the other side to stop sending data or send some more data. When space is available, update credit is sent. Under the system, one side does not overrun the other. A receiver overflow error indicates that something went wrong, e.g., devices on the ends lost track such that one had information indicating it should keep sending, while other side differed. On the CMI link, if such an error is received, the link is stopped because in the time it takes to detect the error, a gap may have been created, a packet may be missing, and data may still be put in memory sequentially, which can create significant issues. If the problem is happening at the Northbridge, notification occurs quickly, such that even if bad data is still going to memory, or if data is missing, the SMI handler is invoked very quickly such that the data is not used before the SP is reset or other action is taken.

A receive overflow error in the SPA domain or the SPB domain is a good example of a PCI Express error that can be bounded to a specific SP such that action (e.g., reset) can be taken specifically with respect to that SP. Even if such an error occurs while data was coming from the other SP, this particular type of error is clearly identifiable as not originating with the other SP; it started and stopped in the instant SP.

On the other hand, if a receive overflow error happens in the inter-SP domain, it is not clear which side miscounted credits, and an error message cannot be sent to either of the other domains as described above. Thus, error detection relies on polling which needs to be frequent enough to catch the error before bad data is passed or generated.

As described above, when it comes time to cause an SP to reset, the CMI driver invokes the SMI handler to do it. The SMI handler writes to the fault status register and waits a period of time before actually resetting the SP, thus allowing the other SP plenty of time to determine, by polling the to-be-reset SP's fault status register, that such reset is imminent and that a message needs to be delivered external to the system indicating that the system needs service. This way, it is unnecessary for the CMI driver and the SMI handler to negotiate writing to the fault register. Alternatively, the CMI driver could reset the SP via a panic mechanism after performing a memory dump to allow subsequent analysis, but such action which would risk losing useful information from registers that are read by the SMI handler, and would risk losing the ability to store such information persistently.

In a variation, a different type of switch could be used that could act as an endpoint when a poison packet is received, such that the poison packet is not passed along. In such a case, the only communications coming out of the switch would be interrupts or messages indicating a problem. To the extent that such a switch would be non-compliant with PCI Express, switch behavior could be made programmable to suit different applications.

In another variation, e.g., for a NAS application, the switch is used but not its nontransparent ports, such that there is only one domain and all problems remain bounded.

With respect to errors internal to the switch, interrupts or error messages can be used, but in at least one implementation interrupts are used instead of error messages. Only an error message can cause an SMI and get the SMI handler involved initially, but since the switch has its own internal memory queues 432 or 470 that can also get ECC errors which can only cause interrupts, the CMI driver not the SMI handler is initially responsive to such errors, and the SMI handler is responsive to error messages except for those pertaining to soft errors.

In a specific implementation, Northbridge port A is used for the CMI link, and ports B and C are used purely for intra SP communications, e.g., with associated I/O modules. In such a case, a policy may be highly likely to specify resetting the SP in the event of an error on ports B and C because such an error is bounded within the SP, but may be less likely to specify the same in the event of an error on port A because it is less clear which SP was the origin of the error.

Other embodiments are within the scope of the following claims. For example, all or part of one or more of the above-described procedures may be implemented, entirely or in part, in firmware or software or both firmware and software. Such an implementation may be based on technology that is entirely or partly different from PCI Express.

What is claimed is:

1. A method for use in managing communications paths, comprising:
detecting an error on a first storage processor;
determining that the error resulted from a peer-to-peer communication from a second storage processor; and
handling the error on the first storage processor by taking action short of causing the first storage processor to reset.

2. The method of claim 1, further comprising:
causing the second storage processor to reset.

3. The method of claim 1, wherein the peer-to-peer communication occurred over a PCI Express link.

4. The method of claim 1, further comprising:
at the second storage processor, initiating a DMA transaction that includes the peer-to-peer communication.

5. The method of claim 1, further comprising:
at the second storage processor, sending the peer-to-peer communication as part of a cache mirroring operation.

6. The method of claim 1, further comprising:
invoking an interrupt handler in response to the error.

7. The method of claim 1, further comprising:
determining whether the error is bounded within only one of the first and second storage processors.

8. The method of claim 1, further comprising:
polling PCI Express devices to detect the error.

9. The method of claim 1, further comprising:
detecting the error at a Northbridge device.

10. The method of claim 1, further comprising:
detecting the error at a PCI Express switch device.

11. The method of claim 1, further comprising:
by a peer-to-peer communication driver, invoking an interrupt handler to execute in response to the error.

12. The method of claim 1, wherein the error results from a poison packet.

13. A system for use in managing communications paths, comprising:
first logic detecting an error on a first storage processor;
second logic determining that the error resulted from a peer-to-peer communication from a second storage processor; and
third logic handling the error on the first storage processor by taking action short of causing the first storage processor to reset.

14. The system of claim 13, further comprising:
fourth logic causing the second storage processor to reset.

15. The system of claim 13, wherein the peer-to-peer communication occurred over a PCI Express link.

16. The system of claim 13, further comprising:
fourth logic, at the second storage processor, initiating a DMA transaction that includes the peer-to-peer communication.

17. The method of claim 13, further comprising:
fourth logic, at the second storage processor, sending the peer-to-peer communication as part of a cache mirroring operation.

18. The system of claim 13, further comprising:
fourth logic invoking an interrupt handler in response to the error.

19. A system for use in managing communications paths, comprising:
a data storage system having first and second storage processors and disk drives in communication with the first and second storage processors;
first logic detecting an error on the first storage processor;
second logic determining that the error resulted from a peer-to-peer communication from the second storage processor; and
third logic handling the error on the first storage processor by taking action short of causing the first storage processor to reset.

20. The system of claim 19, further comprising:
fourth logic causing the second storage processor to reset.
